(19) United States
(12) Patent Application Publication
(10) Pub. No.: US 2023/0040174 A1
(43) Pub. Date: Feb. 9, 2023

(54) GROWTH SYSTEM

(71) Applicant: VISSER 'S-GRAVENDEEL HOLDING B.V., 'S-GRAVENDEEL (NL)

(72) Inventor: Anthony VISSER, 'S-GRAVENDEEL (NL)

(73) Assignee: VISSER 'S-GRAVENDEEL HOLDING B.V., 'S-GRAVENDEEL (NL)

(21) Appl. No.: 17/794,851

(22) PCT Filed: Jan. 6, 2021
(86) PCT No.: PCT/NL2021/050005

§ 371 Date: Jul. 22, 2022

(30) Foreign Application Priority Data
Jan. 27, 2020 (NL) 2024765

(51) Int. Cl. A01G 9/24; B62B 3/02; A01G 9/14; B62B 3/00

(52) U.S. Cl. CPC A01G 9/247; B62B 3/02; A01G 9/143; B62B 3/005

(57) ABSTRACT

A growth system includes growth trolleys each having at least one carrier configured to support products for growing, and a growth hub including equipment facilitating growth of products from a group comprising fluid supply, nutrient supply, and the like. At least one of the growth hub and the growth trolleys is displaceable relative to the other of the growth trolleys and the growth hub to furnish at least one growth facilitating function to products in at least one of the trolleys, when the at least one of the growth trolleys is adjacent to the growth hub.

The present disclosure relates to a growth system, comprising growth trolleys each having at least one carrier configured to support products for growing.

It is generally known that trolleys or similar devices may be arranged in climate chambers, incubators, breeding cabinets and/or greenhouses, or the like, to cultivate or grow plant or animal products. However, fluid supply, nutrient supply, and the like, are to the best knowledge of the inventors of the present disclosure manually performed by employees, or growth facilitating equipment is provided on each trolley, which is a waste of resources, as the equipment is only intermittently required to be used for each separate trolley.

To address the above and other shortcomings, disadvantages and/or mere inconveniences of the existing technology, it is herein proposed to additionally provide a growth hub comprising equipment facilitating growth of products from a group comprising fluid supply, nutrient supply, and the like, wherein at least one of the growth hub and the growth trolleys is displaceable relative to the other of the growth trolleys and the growth hub, to furnish at least one growth facilitating function to products in at least one of the trolleys, when the at least one of the growth trolleys is adjacent to the growth hub.

Consequently, according to the present disclosure, expensive equipment is arranged on the hub for optimally efficient and preferably near continuous use thereof, and manual labor may be excluded, in particular when an automated transport system is in place to handle movements of trolleys and hubs relative to one another, to enable the complex and expensive equipment on the hub to provide the growth facilitating functions to a plurality of trolleys simultaneously, and/or in succession. The hub may be fixed to a wall, for security and safety, in which case the trolleys, which can normally be rolled over transport wheels for displacement, can be moved to and from the fixed hub. Alternatively, the trolleys may be arranged in a side-by-side relationship for optimum usage of available space, for example in a climate chamber, in which case it may prove to be more efficient to displace the hub relative to (an array of) the trolleys. In either case, the growth facilitating functions are provided when the hub and at least one of the trolleys are adjacent after displacement of either.

The present disclosure also involves a number of preferred embodiments, to which the scope of protection is by no means limited, were said preferred embodiments are set out in the dependent claims and/or detailed in the below embodiment description.

In an embodiment, the carrier may comprise a fluid reservoir with a bottom and an upright boundary, and the growth hub comprises the fluid supply with a fluid holder from which fluid is supplied into the fluid reservoir of the growth trolley, when the one of the growth trolleys is adjacent the growth hub. Then, the reservoir may comprises an overflow at a lower height in the reservoir than the upright boundary, and the growth hub comprises a receptacle configured to receive overflowing fluid. Additionally or alternatively, the water reservoir may comprise a discharge in the form of a through hole in or at a bottom of the reservoir, and the growth hub comprises an extendable arm with a plug at a free end of the extendable arm and an arm drive configured to extend the arm and close the discharge with the plug. In case of such a discharge, the growth hub may further comprise a fluid receiver configured to receive discharged fluid.

In an embodiment with the receptacle or the receiver, the receptacle or receiver may be connected to a buffer to store therein overflown or discharged fluid. Then, the growth hub may further comprise a transfer between the buffer and the fluid reservoir configured to transfer fluid from the buffer to the fluid reservoir, for re-use of the fluid by the fluid supply for supply of fluid into another reservoir of the same or another one of the trolleys.

In an embodiment with the receptacle and the receiver, the overflow and the discharge may be arranged adjacent one another, and the receptacle and the receiver may then be combined into a unitary component to receive overflown and discharged fluid.

In an additional or alternative embodiment, the fluid supply of the growth hub may comprise a pump configured to supply fluid into the reservoir of the one of the growth trolleys. Then, when a transfer is also embodied, the pump may be in fluid connection with at least the fluid holder of the growth hub via a controllable valve system, which is configured to be controlled to connect the pump to the buffer to form the transfer between the buffer and the fluid reservoir to transfer fluid from the buffer to the fluid reservoir. In such an embodiment, the buffer may comprise a fluid level gauge, and the controllable valve system may be configured to connect the pump to the buffer to form the transfer, in response to a signal from the gauge that the buffer is at least approximately full.

In an additional or alternative embodiment, at least one of the growth trolleys may comprise a stack of fluid reservoirs. Then, the growth hub may comprise outlets for fluid supply at levels of each of the fluid reservoirs. Additionally or alternatively, the growth hub may comprise receptacles or receivers at levels of each of the fluid reservoirs.

Following the above reference to aspects of the present disclosure in terms and expressions of the appended independent and dependent claims, below an embodiment description is provided with reference to the appended drawing exhibiting potential embodiments of the present disclosure, to which the scope of protection for the present disclosure is by no means limited and may even encompass, in particular in or for specific jurisdictions, alternatives for aspects and features of appended independent claims. In distinct figures of the appended drawing the same or similar reference signs may be used to identify the same or similar features, aspects, element, components and functional groups thereof, even if referenced in relation to distinct embodiments. In the drawing:

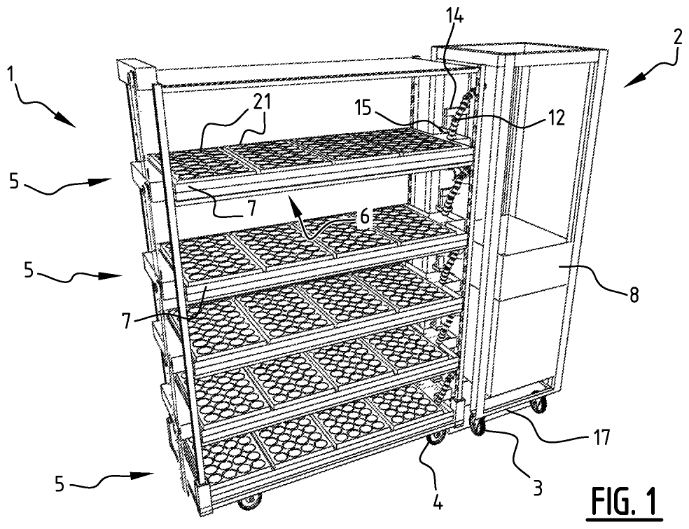

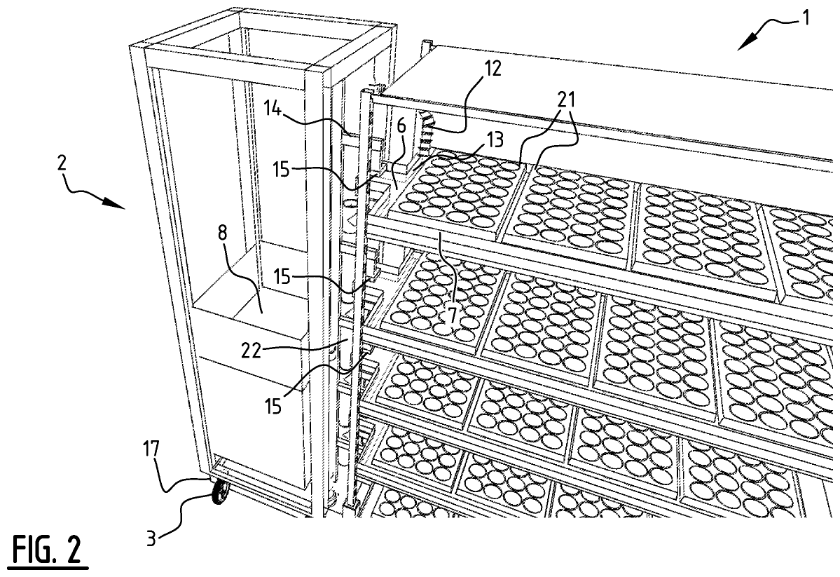

FIGS. 1 and 2 shows perspective views of a trolley and hub, arranged adjacent to one another;

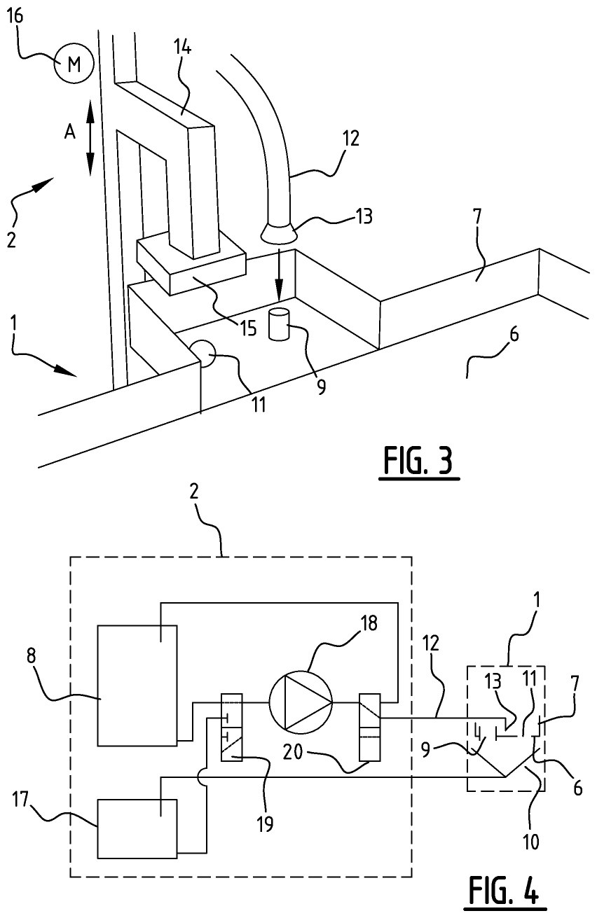

FIG. 3 shows a detail of a carrier in a trolley;

FIG. 4 shows a schematic representation of the hub and one of the trolleys in an adjacent placement thereof; and

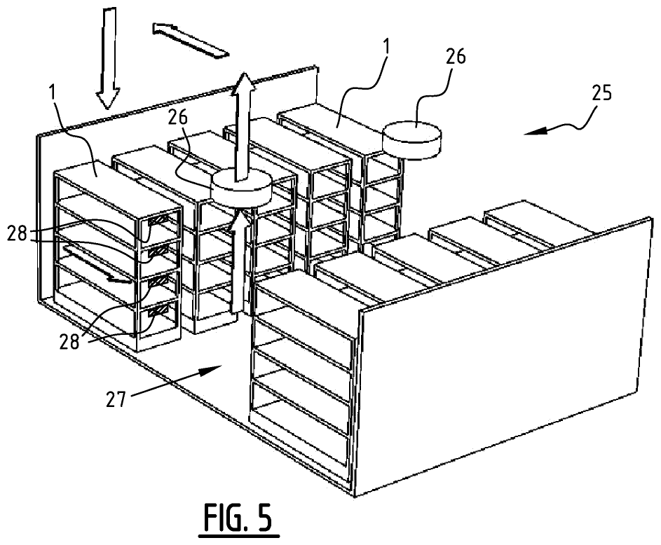

FIG. 5 shows an arrangement of trolleys in a climate chamber.

FIGS. 1, 2 and 3 show a growth trolley 1 and a growth hub 2, together forming a growth system according to the present disclosure. A number of trolleys 1 or devices may be arranged in a climate chamber, an incubator, a breeding cabinet and/or a greenhouse, or the like, to cultivate or grow plant or animal products. In the present case, troll 1 serves to growth plants, but may just as well serve to hold eggs. Trolley 1 and hub 2 are arranged adjacent to one another. To achieve this arrangement, hub 2 is displaceable by rolling hub 2 over wheels 3. Trolley 1 is also displaceable by rolling over wheels 4, mainly for rolling trolleys 1 into and out of a climate chamber or the like. During the stay of these trolleys 1 in the climate chamber or the like, trolleys are preferably left standing, because otherwise the climate chamber or the like must contain more space to allow maneuvering trolleys, which are quite sizeable. For efficient space usage, a plurality of trolleys may be arranged next to the one shown trolley 1, for example next to a long side thereof, to form an array of trolleys 1, as shown in FIG. 5. Hub 2 then is configured and able to be displaced along the array of side-by-side arranged trolleys 1. Evidently, hub 2 is smaller in terms of the circumferential size thereof, and may be maneuvered on a much smaller space, than the trolleys 1. Alternatively, hub 2 may be fixed to a wall, for security and safety, in which case trolleys 1, which can normally be rolled over transport wheels for displacement, can be moved to and from fixed hub 2.

Growth hub 2 comprises equipment facilitating growth of products. In the shown embodiment, hub 2 comprises a fluid supply, to be escribed in more detail herein below. However, alternatively or additionally, hub 2 may comprise a nutrient supply, and the like, to furnish at least one growth facilitating function to products in at least one of the trolleys 1, when growth trolley 1 is adjacent to growth hub 2.

Thereby, expensive equipment is arranged on hub 2 for optimally efficient and preferably near continuous use thereof, and manual labor may be excluded, in particular when an automated transport system is in place to handle movements of trolleys 1 and hubs 2 relative to one another, to enable the complex and expensive equipment on hub 2 to provide the growth facilitating functions to a plurality of trolleys 1 simultaneously, and/or in succession.

The trolley 1 comprises a stack of carriers 5. Each carrier 5 comprises a fluid reservoir with a bottom 6 and an upright boundary wall 7. Hub 2 comprises the fluid supply with a fluid holder 8 from which fluid is supplied into the fluid reservoir 6, 7 of growth trolley 1, via conduit 12 and nozzle 13. The reservoir 6, 7 comprises an overflow 9 at a lower height in the reservoir than the upright boundary wall 7. Hub 2 comprises a receptacle 10 configured to receive fluid overflowing out of the overflow 9. The water reservoir 6, 7 comprises a discharge 11 in the form of a through hole in or at a bottom 6 of the reservoir. Growth hub 2 comprises an extendable arm 14 with a plug 15 at a free end of extendable arm 14 and an arm drive in the form of motor 16 configured to extend the arm 14 and close discharge 11 with plug 15, in an up- or down movement along arrow A in FIG. 3. The receptacle 10 of hub 2 also comprises a fluid receiver configured to receive discharged fluid coming out of discharge in the form of through hole 11. The receptacle 10 in FIG. 3 therefore also serves to receive fluid discharged via the through hole 11 as well as overflow from pipe shaped overflow conduit 9.

As shown in FIG. 4, receptacle 10 is connected to a buffer 17 to store therein overflown and/or discharged fluid. Growth hub 2 preferably further comprises a transfer between the buffer 17 and the fluid reservoir 8 configured to transfer fluid from the buffer 17 to the fluid reservoir 8, for re-use of the fluid by the fluid supply for supply of fluid into another reservoir 6, 7 of the same or another one of the trolleys 1. However, the discharged or overflown fluid may be disposed of or treated before transfer, to avoid contamination, when re-using fluid.

In the shown embodiment, the receptacle 10 is associated with the discharge 11 and the overflow 9, because the overflow 9 and the discharge 11 are arranged adjacent one another. The receptacle 10 is thus combined into a unitary component to receive overflown and discharged fluid. However, separate from the receptacle 10, a receiver may be associated with the discharge 11.

The fluid supply of the growth hub 2 comprises a pump 18 to supply fluid into the reservoir 6, 7 of the one of the growth trolleys 1. A transfer from buffer 17 to holder 8 is also embodied. To this end, the pump is connected with fluid holder 8 and buffer 17 of the growth hub via a controllable valve system, comprising two selector valves 19, 20. With the selector valves 19, 20 in their respective positions shown in FIG. 4, pump 18 is configured to pump fluid from holder 8 into the reservoir(s) 6, 7. When the valves 19, 20 are each reversed in position, pump 18 is configured to transfer fluid from buffer 17 into holder 8. Thus valves 19, 20 are configured to be controlled to connect the pump to buffer 17 to form the transfer between buffer 17 and fluid holder 8 to transfer fluid from buffer 17 to fluid holder 8. Buffer 17 may comprise a fluid level gauge, and the controllable valve system may be configured to connect pump 18 to buffer 17 to form the transfer, in response to a signal from the gauge that buffer 17 is at least approximately full.

Growth trolleys 1 each comprise a stack of fluid reservoirs 6, 7. Growth hub 2 comprises outlets in the form of conduits 12 and nozzles 13 for fluid supply at each level of all of the fluid reservoirs 6, 7. Thereby, reservoirs 6, 7 at the levels of all carriers in the stack of the trolley may be filled simultaneously, up to a point where fluid begins to overflow from each carrier. Overflowing fluid is guided through piping 22 into buffer 17. The water supply into reservoirs 6, 7 is then interrupted, and plants (or at least the substrates in which the roots of the plans grow) in trays 21 are allowed to be drenched. After a predetermined time, and/or if a desired degree of saturation is reached (to which end hub 2 may comprise an extendable humidity meter) discharge 11 may be opened by moving the arm 14 with the plugs 15 upward, freeing the discharges 11 in all reservoirs 6, 7 simultaneously. Discharged fluid is guided through piping 22 to buffer 17. To guide fluid discharged or overflowing from each of the reservoirs 6, 7 of all carriers in trolley 1 to buffer 17, growth hub 2 comprises receptacles 10 at the levels of all of the fluid reservoirs 6, 7.

For efficient space usage, a plurality of trolleys may be arranged next to the one shown trolley 1, for example next to a long side thereof, to form an array of trolleys 1, as shown in FIG. 5. Hub 2 then is configured and able to be displaced along the array of side-by-side arranged trolleys 1. Climate chamber 25, of which only two wall are shown, but which is normally closed, may contain the array of trolleys 1, for a hub 2 (not shown in FIG. 5) to be able to move through a middle aisle 27. Above the middle aisle 27, suction vents 26 attract air from chamber 25 for circulating and possibly processing the air, and re-inserting it into chamber 25, as is schematically indicated with arrows in FIG. 5.

Trolleys 1 may have light beams 28 under carriers 6, 7 to illuminate plant on lower carriers 6, 7, as is shown in FIG. 5 at the leftmost trolley. Such light beams 28 may form part of trolleys 1, and then walls of the chamber 25 may comprise power sockets. However, preferably, light beams 28 are fixed to walls of chamber 25 and trolleys 1 are rolled into position against walls of chamber 25, whereby light beams 28 are inserted into trolleys 1 below carriers 6, 7 thereof. Thus it is possible to comply with a desire to keep trolleys as simple as possible, and restrict the presence of complex or costly devices to hub 2 and/or chamber 25. Preferably LED light beams 28 are employed.

Evidently the present disclosure allow for many additional and/or alternative embodiments relative to those explicitly depicted in the appended drawings and described above in relation thereto. Consequently the scope of protection according to the also appended claims is by no means limited to the explicitly shown and described embodiments, but encompasses alternative and additional embodiments, even if not explicitly referred to, and even encompasses obvious alternatives in certain jurisdictions for elements and components of the appended independent claims.

1. A growth system, comprising:
growth trolleys each having at least one carrier configured to support products for growing; and
a growth hub comprising equipment facilitating growth of products from a group comprising fluid supply, and nutrient supply,
wherein at least one of the growth hub and the growth trolleys is displaceable relative to the other of the growth trolleys and the growth hub, to furnish at least one growth facilitating function to products in at least one of the trolleys, when the at least one of the growth trolleys is adjacent to the growth hub.

2. The growth system according to claim 1, wherein the carrier comprises a fluid reservoir with a bottom and an upright boundary, and the growth hub comprises the fluid supply with a fluid holder from which fluid is supplied into the fluid reservoir of the growth trolley, when the one of the growth trolleys is adjacent the growth hub.

3. The growth system according to claim 2, wherein the reservoir comprises an overflow at a lower height in the reservoir than the upright boundary, and the growth hub comprises a receptacle configured to receive overflowing fluid.

4. The growth system according to claim 2, wherein the water reservoir comprises a discharge in the form of a through hole in or at a bottom of the reservoir, and the growth hub comprises an extendable arm with a plug at a free end of the extendable arm and an arm drive configured to extend the arm and close the discharge with the plug.

5. The growth system according to claim 4, wherein the growth hub further comprises a fluid receiver configured to receive discharged fluid.

6. The growth system according to claim 3, wherein the receptacle or receiver is connected to a buffer to store therein overflown or discharged fluid.

7. The growth system according to claim 6, wherein the growth hub further comprises a transfer between the buffer and the fluid reservoir configured to transfer fluid from the buffer to the fluid reservoir, for re-use of the fluid by the fluid supply for supply of fluid into another reservoir of the same or another one of the trolleys.

8. The growth system according to claim 3, wherein the water reservoir comprises a discharge in the form of a through hole in or at a bottom of the reservoir, and the growth hub comprises an extendable arm with a plug at a free end of the extendable arm and an arm drive configured to extend the arm and close the discharge with the plug, and wherein the growth hub further comprises a fluid receiver configured to receive discharged fluid, and wherein the overflow and the discharge are arranged adjacent one another, and the receptacle and the receiver are combined into a unitary component to receive overflown and discharged fluid.

9. The growth system according to claim 1, wherein the fluid supply of the growth hub comprises a pump configured to supply fluid into the reservoir of the one of the growth trolleys.

10. The growth system according to claim 7, wherein the fluid supply of the growth hub comprises a pump configured to supply fluid into the reservoir of the one of the growth trolleys, and wherein the pump is in fluid connection with at least the fluid holder of the growth hub via a controllable valve system, which is configured to be controlled to connect the pump to the buffer to form the transfer between the buffer and the fluid holder to transfer fluid from the buffer to the fluid holder.

11. The growth system according to claim 10, wherein the buffer comprises a fluid level gauge, and the controllable valve system is configured to connect the pump to the buffer to form the transfer, in response to a signal from the gauge that the buffer is at least approximately full.

12. The growth system according to claim 1, wherein at least one of the growth trolleys comprises a stack of fluid reservoirs.

13. The growth system according to claim 12, wherein the growth hub comprises outlets for fluid supply at levels of each of the fluid reservoirs.

14. The growth system according to claim 3, wherein at least one of the growth trolleys comprises a stack of fluid reservoirs, and wherein the growth hub comprises receptacles or receivers at levels of each of the fluid reservoirs.

15. The growth system according to claim 3, wherein at least one of the growth trolleys comprises a stack of fluid reservoirs, wherein the growth hub comprises outlets for fluid supply at levels of each of the fluid reservoirs, and wherein the growth hub comprises receptacles or receivers at levels of each of the fluid reservoirs.

16. The growth system according to claim 5, wherein at least one of the growth trolleys comprises a stack of fluid reservoirs, and wherein the growth hub comprises receptacles or receivers at levels of each of the fluid reservoirs.

17. The growth system according to claim 5, wherein at least one of the growth trolleys comprises a stack of fluid reservoirs, wherein the growth hub comprises outlets for fluid supply at levels of each of the fluid reservoirs, and wherein the growth hub comprises receptacles or receivers at levels of each of the fluid reservoirs.
